(19) United States
(12) Patent Application Publication
(10) Pub. No.: US 2015/0183175 A1
(43) Pub. Date: Jul. 2, 2015

(54) MEMBRANES MADE FROM 6FDA, DETDA, AND DABA-BASED POLYMERS

(71) Applicant: American Air Liquide, Inc., Fremont, CA (US)

(72) Inventors: Edgar SANDERS, Newark, DE (US); Sudhir S. KULKARNI, Wilmington, DE (US)

(73) Assignee: American Air Liquide, Inc., Fremont, CA (US)

(21) Appl. No.: 14/140,981

(22) Filed: Dec. 26, 2013

(51) Int. Cl. B29D 99/00; B29C 47/00; C08G 73/10

(52) U.S. Cl. CPC B29D 99/005; C08G 73/1067; B29C 47/0059; B29K 2079/085

(57) ABSTRACT

A polymeric membrane made of a polyimide polymer or copolymer essentially consisting of repeating units of dianhydride-derived units and diamine-derived units. At least some of the dianhydride-derived units are derived from 2,2-bis(3,4-dicarboxyphenyl)hexafluoropropane (6FDA). At least some of the diamine-derived units are derived from 2,5-diethyl-6-methyl-1,3-diamino benzene (DETDA). The balance of the diamine-derived units are derived from a diamino benzene ring with a carboxylic acid substituent.

### CROSS-REFERENCE TO RELATED APPLICATIONS

None.

### BACKGROUND

1. Field of the Invention

The present invention relates to carbon molecular sieve membranes and gas separations utilizing the same.

2. Related Art

Membranes are viewed as selective barriers between two phases. Due to the random thermal fluctuations within the polymer matrix, gas molecules from the high partial pressure side sorb into the membrane and diffuse through under the influence of a chemical potential gradient, and finally desorb to the low partial pressure side. Two terms, “permeability” and “selectivity”, are used to describe the most important properties of membranes-productivity and separation efficiency respectively. Permeability (P) equals the pressure and thickness normalized flux, as shown in the following equation:

$${P}_{i} = \frac{{n}_{i} l}{Δ {p}_{i}} \qquad ( 1 )$$

where nᵢ is the penetrant flux through the membrane of thickness (/) under a partial pressure (Δpᵢ). The most frequently used unit for permeability, Barrer, is defined as below:

$$Barrer = {10}^{- 10} \frac{cc ( STP ) \cdot cm}{{cm}^{2} \cdot s \cdot cmHg} \qquad ( 2 )$$

Selectivity is a measure of the ability of one gas to flow through the membrane over that of another gas. When the downstream pressure is negligible, the ideal selectivity (based upon the permeabilities of pure gases) of the membrane, can be used to approximate the real selectivity (based upon the permeabilities of the gases in a gas mixture). In this case, the selectivity (α_{A/B}) is the permeability of a first gas A divided by the permeability of a second gas B.

Currently, polymeric membranes are well studied and widely available for gaseous separations due to easy processability and low cost. In particular, polyimides have high glass transition temperatures, are easy to process, and have one of the highest separation performance properties among other polymeric membranes. The patent literature (including US 2011/138852; U.S. Pat. No. 5,618,334; U.S. Pat. No. 5,928,410; and U.S. Pat. No. 4,981,497) discloses one particular class of polyimides for use in polymeric gas separation membranes that is based upon the reaction of a diamine(s) with 2,2-bis(3,4-dicarboxyphenyl) hexafluoropropane dianhydride (6FDA).

### SUMMARY

There is disclosed a membrane comprising a polyimide polymer or copolymer having repeating units of dianhydride-derived units and diamine-derived units, at least some of, and as much as 100% of, the dianhydride-derived units being the dianhydride-derived moiety of formula (I) with a balance of the dianhydride-derived units, if any, being the dianhydride-derived moiety of formula (II)

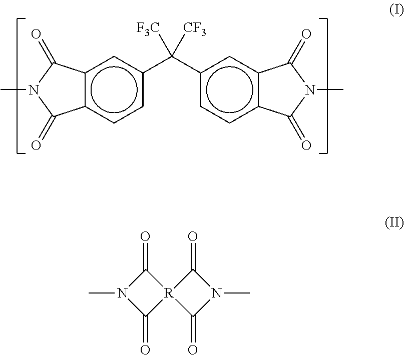

Each R is a molecular segment independently selected from the group consisting of formula (1), formula (2), formula (3), and formula (4)

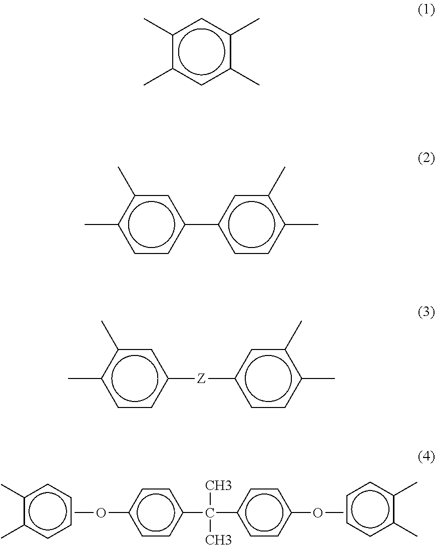

Each Z is a molecular segment independently selected from the group consisting of formula (5), formula (6), formula (7), and formula (8)

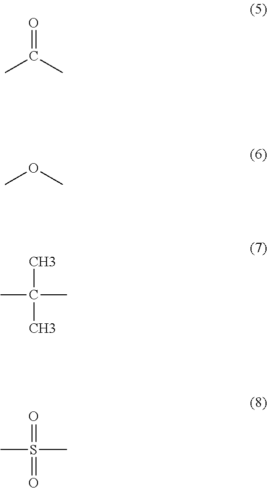

At least some of the diamine-derived units are the diamine-derived moiety of formula (A)

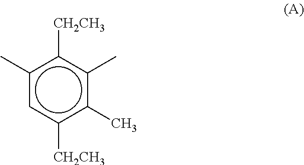

At least some of the diamine-derived units are the diamine-derived moiety of formula (B) or formula (C):

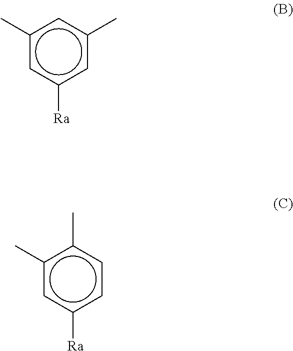

Each Rₐ is a straight or branched C₁ to C₆ alkyl group having a terminal carboxylic acid group.

There is also disclosed a method of producing a hollow fiber membrane that includes the following steps. A solution or suspension of a polyimide polymer or copolymer binder and a solvent for the binder is prepared. A spinneret adapted and configured to continuously extrude one or more nascent hollow fibers is provided. The spinneret has an inner annular channel disposed concentrically within an outer annular channel. A bore fluid is fed through the inner annular channel to form a cylindrical fluid stream positioned concentrically within the fiber. The solution or suspension is fed through the outer annular channel so that it surrounds the cylindrical fluid stream to form a nascent hollow fiber. The nascent hollow fiber is passed from the spinneret through an air gap. The nascent hollow fiber is immersed in a liquid coagulant to facilitate phase inversion. The fiber is removed from the coagulant. The polymide polymer or copolymer has repeating units of dianhydride-derived units and diamine-derived units, at least some of, and as much as 100% of, the dianhydride-derived units being the dianhydride-derived moiety of formula (I) with a balance of the dianhydride-derived units, if any, being the dianhydride-derived moiety of formula (II)

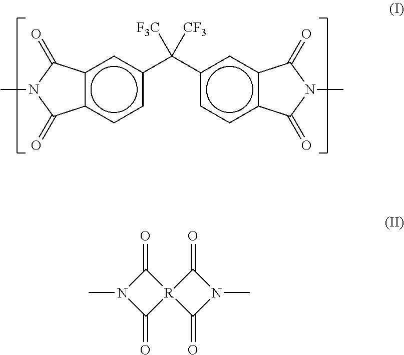

Each R is a molecular segment independently selected from the group consisting of formula (1), formula (2), formula (3), and formula (4)

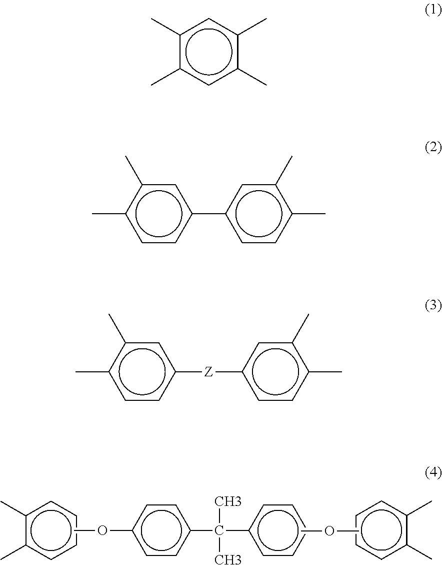

Each Z is a molecular segment independently selected from the group consisting of formula (5), formula (6), formula (7), and formula (8)

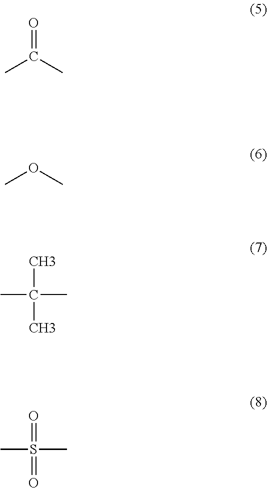

At least some of the diamine-derived units are the diamine-derived moiety of formula (A)

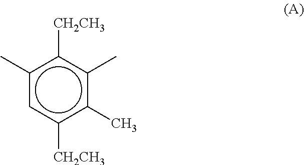

At least some of the diamine-derived units are the diamine-derived moiety of formula (B) or formula (C):

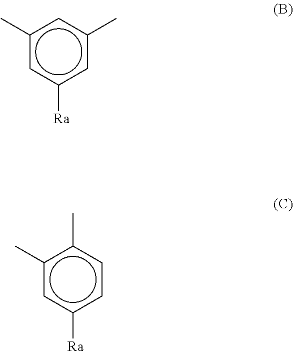

Each Rₐ is a straight or branched C₁ to C₆ alkyl group having a terminal carboxylic acid group.

The membrane and/or method may include one or more of the following aspects:
100% of the dianhydride-derived units are the dianhydride-derived moiety of formula (I).
Rₐ is a —COOH group.
less than 100% of the dianhydride-derived units are the dianhydride-derived moiety of formula (I) and the balance of the dianydride-derived units are the dianhydride-derived moiety of formula (II).
Rₐ is a —COOH group.
R is the molecular segment of formula (2).
Z is the molecular segment of formula (5).
Rₐ is a —COOH group.
R is the molecular segment of formula (3).
Z is the molecular segment of formula (5).
Rₐ is a —COOH group.
a ratio of the diamine-derived moieties of formula (A) to that of either formula (B) or formula (C) ranges from about 3:2 to about 2:3.

### DESCRIPTION OF PREFERRED EMBODIMENTS

The membranes of the invention are expected to exhibit relatively high permeabilities and selectivities in various gas separations, including CO₂/CH₄, O₂/N₂, and C₃H₆/C₃H₈.

The membrane is made from a polyimide polymer or copolymer having repeating units of dianhydride-derived units and diamine-derived units.

At least some (and as much as 100%) of the dianhydride-derived units are the dianhydride-derived moiety of formula (I) with the balance (if any) being the dianhydride-derived moiety of formula (II):

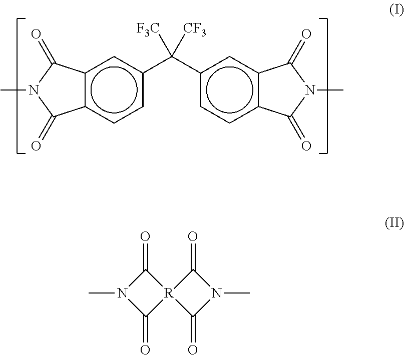

Each R is a molecular segment independently selected from the group consisting of formula (1), formula (2), formula (3), and formula (4):

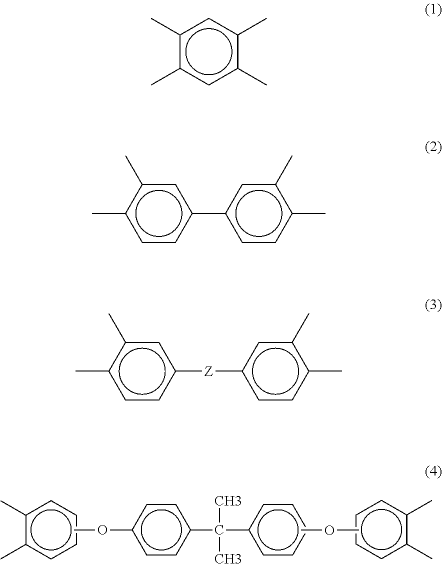

By independently selected, we mean that each R need not be the same, however, typically it is.

Each Z is a molecular segment independently selected from the group consisting of formula (5), formula (6), formula (7), and formula (8).

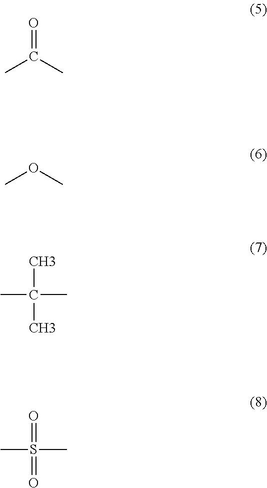

By independently selected, we mean that each Z need not be the same, however, typically it is.

At least some of the diamine-derived units are the diamine-derived moiety of formula (A):

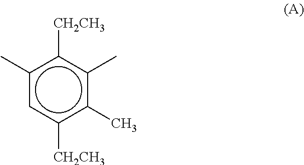

At least some of the diamine-derived units are the diamine-derived moiety of formula (B) or formula (C):

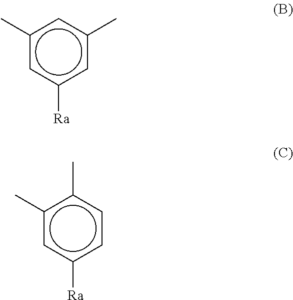

Each Rₐ is a straight or branched C₁ to C₆ alkyl group having a terminal carboxylic acid group. Typically, Rₐ is a —COOH group. The diamine-derived units of formula (B) where Rₐ is a —COOH group is conventionally termed DABA. Typically, the ratio of the diamine-derived moieties of formula (A) to that of either formula (B) or formula (C) ranges from about 3:2 to about 2:3.

The dianhydride-derived moiety of formula (I) is conventionally termed 6FDA and is derived from 2,2′-bis(3,4-dicarboxyphenyl hexafluoropropane). We believe that the 6FDA molecular segment exhibits many attractive properties. Polyimides incorporating 6FDA have limited rotational mobility of the polymer chain. This results in polyimides with both hindered packing density and high glass transition. These molecular properties result in membranes with relatively high permeance for a given selectivity as well as high temperature capability.

The diamine-derived moiety of formula (A) is conventionally termed DETDA. The DETDA molecular segment includes an ethyl group that is ortho to the phenyl to nitrogen bond of the imide linkage of the polyimide. We believe that this relatively bulky group sterically inhibits rotation of the polymer around that bond. Without being bound by any particular theory, we believe that this sterically inhibited rotation renders the polyimide more rigid. The relatively bulky group also inhibits close chain packing. These molecular properties can further enhance the desired membrane properties of high permeance and temperature capability

The Rₐ substituent of the diamine-derived moiety of formula (B) or formula (C) allows cross-linking between the Rₐ substituents on adjacent polymer chains via the esterification route. When Rₐ is a —COOH group, the diamine-derived moiety of formula (B) is conventionally termed DABA. Cross-linking can be used to achieve higher selectivity for higher separation efficiency and to maintain this high selectivity when exposed to plasticizing species in the gas mixture to be separated as well as conditions such as high temperature and high pressure.

In one embodiment, 100% of the dianhydride-derived units are the dianhydride-derived moiety of formula (I). Typically, Rₐ is a —COOH group.

In another embodiment, less than 100% of the dianhydride-derived units are the dianhydride-derived moiety of formula (I) with the balance being the dianhydride-derived units are the dianhydride-derived moiety of formula (II). Typically, Rₐ is a —COOH group. Also typically, R is the molecular segment of either formula (2) or (3) where Z is the molecular segment of formula (5).

The polyimide polymer or copolymer may be synthesized by reacting, in any one of a wide variety of known polyimide synthesis methods, stoichiometric amounts of one or more dianhydrides and one or more diamines to form the intermediate poly(amic acid) followed by removal of water to form the polyimide by ring-closing. The skilled artisan will understand that a stoichiometric amount of a dianhydride reacted with a stoichiometric amount of a mixture of diamines will result in a random copolymer. Alternatively, a block copolymer of the dianhydride and one or more diamines may be synthesized according to known methods in which case the diamines are not initially in admixture. The skilled artisan will similarly understand that a stoichiometric amount of a mixture of dianhydrides reacted with a stoichiometric amount of a diamine will also form a random copolymer and that a block copolymer may alternatively be synthesized according to known methods in which case the dianhydrides are not initially in admixture. Finally, the skilled artisan will further understand that a stoichiometric amount of a mixture of dianhydrides reacted with a stoichiometric amount of a mixture of diamines will result in a random polymer and that a block copolymer may alternatively be synthesized according to known methods in which case the dianhydrides are not initially in admixture and the diamines are not initially in admixture.

At least some of the dianhydride is 2,2′-bis(3,4-dicarboxyphenyl hexafluoropropane) which conventionally termed 6FDA and whose molecular structure is shown by formula I′:

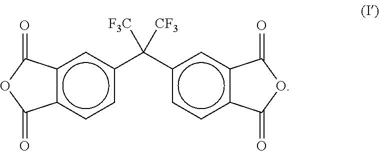

When less than 100% of the dianhydride is 6FDA, the balance of the dianhydride is shown by formula II′:

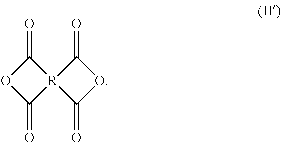

Each R is as defined above. Typically, the balance of the dianhydride is 4,4′-biphthalic dianhydride (BPDA) or benzophenone-3,3′,4,4′-tetracarboxylic dianhydride (BTDA):

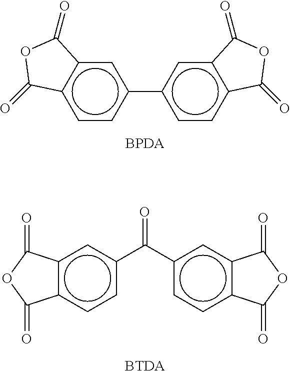

Some of the diamines are 2,5-diethyl-6-methyl-1,3-diamino benzene (DETDA):

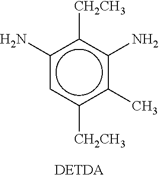

The balance of the diamines are the diamine of formula A′ or formula B′, where Rₐ is as defined above.

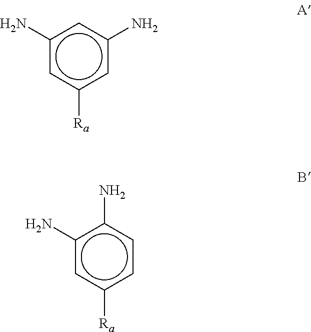

When the balance of the diamines are the diamine of formula (A) and Rₐ is a —COOH the balance of the diamines are conventionally termed 3,5-diaminobenzoic acid (DABA).

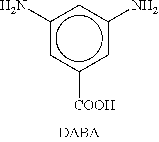

When the balance of the diamines are the diamine of formula (B) and Rₐ is a —COOH the balance of the diamines are conventionally termed 3,4-diaminobenzoic acid.

More typical polyimides include: 6FDA/DETDA:DABA (polymerized using 6FDA and a mixture of DETDA and DABA); 6FDA:BPDA/DETDA:DABA (polymerized using a mixture of 6FDA and BPDA and a mixture of DETDA and DABA), and 6FDA:BTDA/DETDA:DABA (polymerized with a mixture of 6FDA and BTDA and a mixture of DETDA and DABA).

While the membrane may have any configuration known in the field of gas separation, typically it is formed as a plurality of hollow fibers.

The polyimide is optionally dried and later dissolved in a suitable solvent to provide a precursor solution (known as a spin dope in the case of hollow fiber spinning). The drying may be carried out in, for example, a drying vacuum oven, typically at a temperature ranging from 110-150° C. for at least 6 hours (and as much as 6-12 hours). Drying is considered to be completed once a steady weight is achieved. Other known methods of drying such as heating in an inert gas purge may additionally or alternatively be employed.

Dissolution in, and homogenous distribution of, the polyimide in the solvent may be enhanced by mixing with any known mixing device, including rollers, stirrer bars, and impellers. In the case of a hollow fiber membrane, the precursor solution may be mixed for 6 hours to 30 days (optionally 3-10 days or even 3-7 days).

The concentration of the polyimide in the precursor solution is typically driven by the configuration of the polymeric membrane. For example, a concentration ranging from 15-35 wt % (or optionally 18-30 wt % or even 22-28 wt %) is suitable for spinning hollow fibers.

Suitable solvents may include, for example, dichloromethane, tetrahydrofuran (THF), N-methyl-2-pyrrolidone (NMP), and others in which the resin is substantially soluble, and combinations thereof. For purposes herein, “substantially soluble” means that at least 98 wt % of the polymer in the solution is solubilized in the solvent. Typical solvents include N-methylpyrrolidone (NMP), N,N-dimethylacetamide (DMAC), N,N-dimethylformamide (DMF), dimethyl sulfoxide (DMSO), gamma-butyrolactone (BLO), dichloromethane, THF, glycol ethers or esters, and mixtures thereof.

In a membrane configured as hollow fibers, the hollow fibers may be spun by any conventional method. A typical procedure for producing hollow fibers of this invention can be broadly outlined as follows. A bore fluid is fed through an inner annular channel of spinneret designed to form a cylindrical fluid stream positioned concentrically within the fibers during extrusion of the fibers. A number of different designs for hollow fiber extrusion spinnerets known in the art may be used. Suitable embodiments of hollow-fiber spinneret designs are disclosed in U.S. Pat. No. 4,127,625 and U.S. Pat. No. 5,799,960, the entire disclosures of which are hereby incorporated by reference. The bore fluid is preferably water, but a mixture of water and an organic solvent (for example NMP) may be used as well. The precursor solution is fed through an outer annular channel of the spinneret so that it surrounds the bore fluid to form a nascent polymeric hollow fiber.

The diameter of the eventual solid polymeric fiber is partly a function of the size of the hollow fiber spinnerets. The outside diameter of the spinneret can be from about 400 μm to about 2000 μm, with bore solution capillary-pin outside diameter from 200 μm to 1000 μm. The inside diameter of the bore solution capillary is determined by the manufacturing limits for the specific outside diameter of the pin.

The temperature of the solution during delivery to the spinneret and during spinning of the hollow fiber depends on various factors including the desired viscosity of the dispersion within the spinneret and the desired fiber properties. At higher temperature, viscosity of the dispersion will be lower, which may facilitate extrusion. At higher spinneret temperature, solvent evaporation from the surface of the nascent fiber will be higher, which will impact the degree of asymmetry or anisotropy of the fiber wall. In general, the temperature is adjusted to maintain the desired viscosity of the dispersion and the fiber wall asymmetry. Typically, the temperature is from about 20° C. to about 100° C., preferably from about 20° C. to about 60° C.

Upon extrusion from the spinneret, the nascent polymeric hollow fiber is passed through an air gap and immersed in a suitable liquid coagulant bath to facilitate phase inversion of the dissolved polyimide and solidification of the fiber structure. The coagulant constitutes a non-solvent or a poor solvent for the polymer while at the same time a good solvent for the solvent within the dispersion. As a result, the solvent for the polymer is extracted from the nascent fiber causing the polymer to solidify as it is drawn through the quench bath. Suitable liquid coagulants include water (with or without a water-soluble salt) and/or alcohol with or without other organic solvents. Typically, the liquid coagulant is water.

The solidified fiber is then withdrawn from the coagulant and wound onto a rotating take-up roll, drum, spool, bobbin or other suitable conventional collection device. Before or after collection, the fiber may optionally be washed to remove any residual solvent. After collection, the fiber may optionally be dried to remove any remaining volatile material.

Other exemplary conventional processes for producing polymeric hollow fibers are disclosed in U.S. Pat. No. 5,015,270, U.S. Pat. No. 5,102,600, and Clausi, et al., (Formation of Defect-free Polyimide, Hollow Fiber Membranes for Gas Separations, Journal of Membrane Science, 167 (2000) 79-89), the entire disclosures of which are hereby incorporated by reference herein.

The completed fibers have an outer diameter that typically ranges from about 150-550 μm (optionally 200-300 μm) and an inner diameter that typically ranges from 75-275 μm (optionally 100-150 μm). In some cases unusually thin walls (for example, thicknesses less than 30 μm) may be desirable to maximize productivity while maintaining desirable durability.

The hollow fibers may be used to make a gas separation membrane according to any number of well-known methods of manufacturing gas separation membranes based upon polymeric hollow fibers. Alternatively, the hollow fibers may be used to make a carbon molecular sieve (CMS) membrane after pyrolysis to substantially carbonize the hollow fibers according to any number of well-known methods of manufacturing CMS membranes.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A membrane comprising a polyimide polymer or copolymer having repeating units of dianhydride-derived units and diamine-derived units, at least some of, and as much as 100% of, the dianhydride-derived units being the dianhydride-derived moiety of formula (I) with a balance of the dianhydride-derived units, if any, being the dianhydride-derived moiety of formula (II) 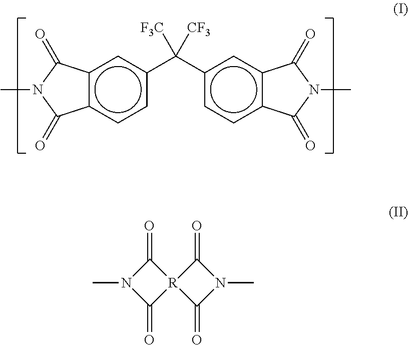
wherein:
each R is a molecular segment independently selected from the group consisting of formula (1), formula (2), formula (3), and formula (4) 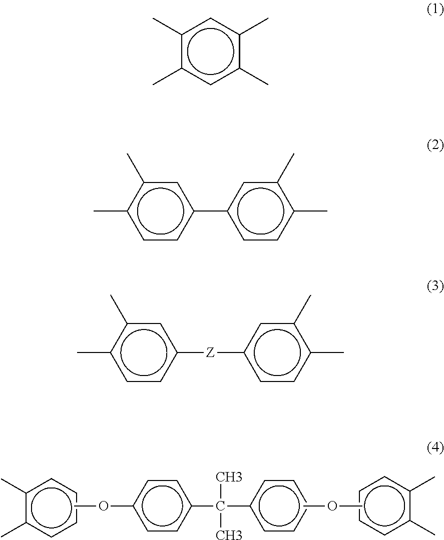
each Z is a molecular segment independently selected from the group consisting of formula (5), formula (6), formula (7), and formula (8) 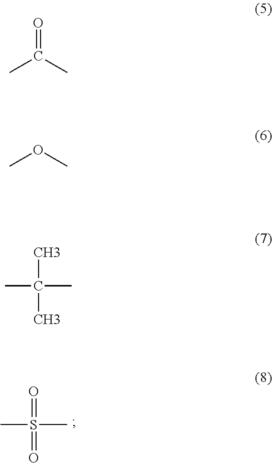
at least some of the diamine-derived units are the diamine-derived moiety of formula (A) 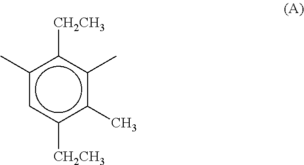
at least some of the diamine-derived units are the diamine-derived moiety of formula (B) or formula (C): 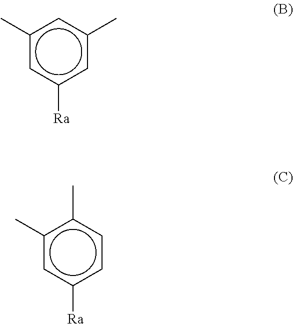
and
each Rₐ is a straight or branched C₁ to C₆ alkyl group having a terminal carboxylic acid group.

2. The membrane of claim 1, wherein 100% of the dianhydride-derived units are the dianhydride-derived moiety of formula (I).

3. The membrane of claim 2, wherein Rₐ is a —COOH group.

4. The membrane of claim 1, wherein less than 100% of the dianhydride-derived units are the dianhydride-derived moiety of formula (I) and the balance of the dianydride-derived units are the dianhydride-derived moiety of formula (II).

5. The membrane of claim 4, wherein Rₐ is a —COOH group.

6. The membrane of claim 4, wherein R is the molecular segment of formula (2).

7. The membrane of claim 6, wherein Z is the molecular segment of formula (5).

8. The membrane of claim 7, wherein Rₐ is a —COOH group.

9. The membrane of claim 4, wherein R is the molecular segment of formula (3).

10. The membrane of claim 9, wherein Z is the molecular segment of formula (5).

11. The membrane of claim 10, wherein Rₐ is a —COOH group.

12. The membrane of claim 1, wherein a ratio of the diamine-derived moieties of formula (A) to that of either formula (B) or formula (C) ranges from about 3:2 to about 2:3.

13. A method of producing a hollow fiber membrane, comprising the steps of:
preparing a solution or suspension of a polyimide polymer or copolymer binder and a solvent for the binder;
providing a spinneret adapted and configured to continuously extrude one or more nascent hollow fibers, the spinneret having an inner annular channel disposed concentrically within an outer annular channel;
feeding a bore fluid through the inner annular channel to form a cylindrical fluid stream positioned concentrically within the fiber;
feeding the solution or suspension through the outer annular channel so that it surrounds the cylindrical fluid stream to form a nascent hollow fiber;
passing the nascent hollow fiber from the spinneret through an air gap;
immersing the nascent hollow fiber in a liquid coagulant to facilitate phase inversion; and
removing the fiber from the coagulant, wherein:
the polymide polymer or copolymer has repeating units of dianhydride-derived units and diamine-derived units, at least some of, and as much as 100% of, the dianhydride-derived units being the dianhydride-derived moiety of formula (I) with a balance of the dianhydride-derived units, if any, being the dianhydride-derived moiety of formula (II) 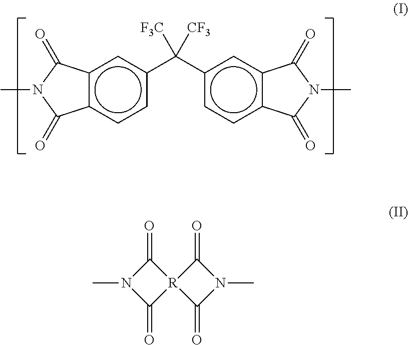
wherein:
each R is a molecular segment independently selected from the group consisting of formula (1), formula (2), formula (3), and formula (4) 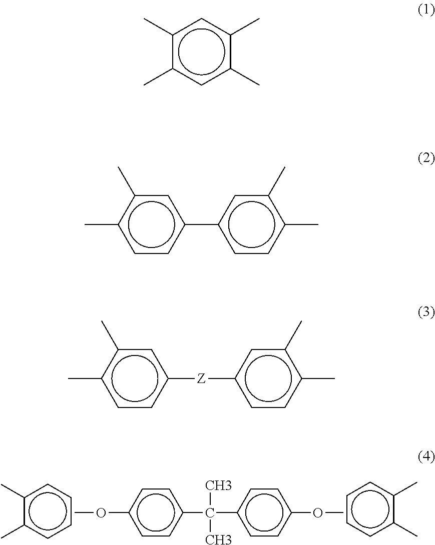
each Z is a molecular segment independently selected from the group consisting of formula (5), formula (6), formula (7), and formula (8) 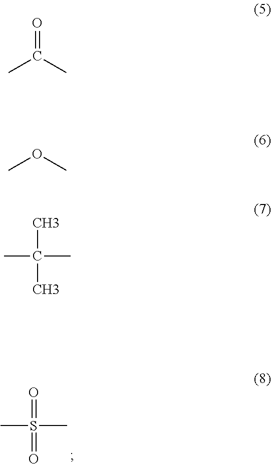
at least some of the diamine-derived units are the diamine-derived moiety of formula (A) 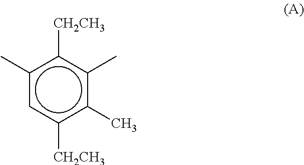
at least some of the diamine-derived units are the diamine-derived moiety of formula (B) or formula (C): 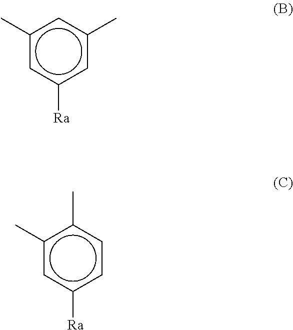
and
each Rₐ is a straight or branched C₁ to C₆ alkyl group having a terminal carboxylic acid group.
